(19) United States
(12) Patent Application Publication
(10) Pub. No.: US 2018/0062336 A1
(43) Pub. Date: Mar. 1, 2018

(54) CRIMPING HAND TOOL

(71) Applicant: JETOOL CORP., New Taipei City (TW)

(72) Inventor: Kai-Yen Lin, New Taipei City (TW)

(73) Assignee: JETOOL CORP., New Taipei City (TW)

(21) Appl. No.: 15/464,355

(22) Filed: Mar. 21, 2017

Related U.S. Application Data
(60) Provisional application No. 62/378,690, filed on Aug. 24, 2016.

(30) Foreign Application Priority Data
Jan. 13, 2017 (TW) 106101145

(51) Int. Cl. H01R 43/042

(52) U.S. Cl. CPC H01R 43/0421

(57) ABSTRACT

A crimping hand tool used for crimping a housing and a plurality of wires of a cable together to be a connector is provided. The crimping hand tool includes a first body having a guiding structure, a second body pivoted to the first body, a linking member having a first end and a second end opposite to each other, a crimping assembly, and at least one blade. The second end is pivoted to the second body. The crimping assembly is pivoted to the first end and slidably coupled to the guiding structure. The first and the second bodies rotate so as to move the linking member and drive the crimping assembly to crimp the wires into the housing in a crimping direction. The blade moves with the crimping assembly to cut off a portion of the wires extending out of the housing simultaneously.

### CROSS-REFERENCE TO RELATED APPLICATION

This application claims the priority benefits of U.S. provisional application Ser. No. 62/378,690, filed on Aug. 24, 2016 and Taiwan application serial no. 106101145, filed on Jan. 13, 2017. The entirety of each of the above-mentioned patent application is hereby incorporated by reference herein and made a part of this specification.

### BACKGROUND OF THE INVENTION

### 1. Field of the Invention

The invention relates to a crimping hand tool.

### 2. Description of Related Art

Nowadays, various signal cables and signal connectors have been broadly used for signal transmission. Examples of such cables and connectors include the network cables and RJ45 connectors, which serve to transmit network signals, and the telephone cables and RJ11 connectors, which serve to transmit telephone signals, etc. In order to connect the cable to a device as desired, it is common that the terminal of the cable is connected with the corresponding connector to form a cable connector. Under such circumstance, a specialized cable crimping tool is needed to connect and fix the cable to the connector.

### SUMMARY OF THE INVENTION

The invention provides a hand tool for crimping a plurality of wires of a cable into a housing to form a cable connector.

A crimping hand tool according to an embodiment is provided for crimping a housing and a plurality of wires of a cable together to be a connector. The crimping hand tool includes a first body, a second body, a linking member, a crimping assembly, and at least one blade. The first body has a guiding structure. The second body is pivoted to the first body and rotates with respect to the first body. The linking member has a first end and a second end opposite to each other, and the second end is pivoted to the second body. The crimping assembly is pivoted to the first end and slidably coupled to the guiding structure. The second body and the first body rotate with respect to each other to move the linking member, and drives the crimping assembly to crimp the wires into the housing in a crimping direction. The blade is assembled to the crimping assembly and moves with the crimping assembly, and cuts off a portion of the wires extending out of the housing simultaneously when the crimping assembly crimps the cores to the housing.

According to an embodiment of the invention, the guiding structure is at least one guiding slot, at least one guiding protruding part, or at least one guiding surface in the first body.

According to an embodiment of the invention, the first body includes a main body and a pair of side plates. The main body has an accommodating space and the guiding structure, and the linking member is movably disposed in the accommodating space.

According to an embodiment of the invention, the side plates respectively have bores. The bores are opposite to each other and intervened by the accommodating space. The crimping assembly has a pivot shaft, and two ends of the pivot axis are respectively coupled to the bores. An extending direction of each bore is consistent with the crimping direction.

According to an embodiment of the invention, the first body has a first crimping slot connected with the accommodating space, and the housing is moved into the first crimping slot after the wires pass through the housing. The crimping assembly includes a first crimping member and a second crimping member. The first crimping member and the second crimping member are respectively pivoted to the first end of the linking member via the pivot shaft, so as to be driven by the linking member to make the first crimping member and a portion of the second crimping member enter and exit the first crimping slot synchronously, thereby crimping different portions of the housing. The linking member is located between the first crimping member and the second crimping member.

According to an embodiment of the invention, the at least one blade includes a first blade assembled to the first crimping member. The first blade follows the first crimping member to enter and exit the first crimping slot, so as to cut off a portion of the wires extending out of the housing.

According to an embodiment of the invention, the first body has a second crimping slot connected with the accommodating space. A plurality of wires of a plurality of cable are suitable to be moved to the second crimping slot after passing through another housing. The crimping assembly includes a third crimping member. The third crimping member is linked between the first crimping member and the second crimping member, so as to move with the first crimping member and the second crimping member. The third crimping member and another portion of the second crimping member enter and exit the second crimping slot synchronously.

According to an embodiment of the invention, the at least one blade includes a second blade assembled to the third crimping member. The second blade follows the third crimping member to enter and exit the second crimping slot, so as to cut off a portion of the wires of the another cable extending out of the another housing.

According to an embodiment of the invention, each of the first crimping slot and the second crimping slot penetrates through the main body in an axial direction, and the axial directions are respectively orthogonal to the crimping direction.

According to an embodiment of the invention, the guiding structure is located between the accommodating space and the first crimping slot and the second crimping slot. The first crimping member, the second crimping member, and the third crimping member respectively enter and exit the first crimping slot and the second crimping slot along the guiding structure.

According to an embodiment of the invention, the guiding structure is located between the accommodating space and the first crimping slot. The first crimping member and the second crimping member respectively enter and exit the first crimping slot along the guiding structure.

According to an embodiment of the invention, the second end of the linking member is adjacent to where the first body and the second body are pivoted, and the first end of the linking member is adjacent to the first crimping slot.

According to an embodiment of the invention, the first body includes a main body and a pair of side plates. The main body has an accommodating space. The linking member is movably disposed in the accommodating space. The side plates are respectively assembled to opposite sides of the main body. Each of the side plates has a bore. The bores are opposite to each other and intervened by the accommodating space. An extending direction of each bore is consistent with the crimping direction. A pivot shaft of the crimping assembly is located in the accommodating space, and two ends of the pivot shaft are respectively coupled to the bores. In addition, the pair of bores and at least one guiding slot, at least one guiding protruding portion, or at least one guiding surface of the main body form the guiding structure.

According to an embodiment of the invention, a pivotal axial direction of the first body and the second body is orthogonal to the crimping direction.

According to an embodiment of the invention, the crimping direction is away from where the first body and the second body are pivoted.

According to an embodiment of the invention, the crimping hand tool further includes a ratchet structure and a stopping block. The ratchet structure is disposed to one of the first body and the second body, so as to move in accordance with rotating of the first body and the second body. The stopping block is rotatably disposed to the other of the first body and the second body, and partially interferes with a movement path of the ratchet structure, so as to temporarily lock the ratchet structure when the first body and the second body are rotating with respect to each other.

According to an embodiment of the invention, the crimping hand tool further includes an elastic member. The elastic member is disposed to the first body or the second body together with the stopping block. A direction that the elastic member drives the stopping block is opposite to a direction that the ratchet structure drives the stopping block.

According to an embodiment of the invention, the ratchet structure faces away from where the first body and the second body are pivoted.

According to an embodiment of the invention, the ratchet structure faces toward where the first body and the second body are pivoted.

According to an embodiment of the invention, the crimping hand tool further includes a ratchet structure and a stopping block. The ratchet structure is disposed to one of the linking member and the second body, so as to move with the linking member or the second body. The stopping block is rotatably disposed to the other of the linking member and the second body, and partially interferes with a movement path of the ratchet structure, so as to temporarily lock the ratchet structure when the linking member and the second body move with respect to each other.

According to an embodiment of the invention, the crimping hand tool further includes an elastic member. The elastic member is disposed to the linking member or the second body together with the stopping block. In addition, a direction that the elastic member drives the stopping block is opposite to a direction that the ratchet structure drives the stopping block.

Based on the above, with the first body and the second body pivoted to each other and the linking member between the first body and the second body in the crimping hand tool, when the first body and the second body rotate with each other, the linking member may drive the crimping assembly to move along an axial direction through the rotation of the linking member itself and the guiding structure, so that the cable and the housing are crimped together. Furthermore, the blade is disposed on the crimping assembly to be linked with the crimping assembly, so that the blade may cut off the wires of the cable extending out of the housing simultaneously when the crimping operation is performed.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a crimping hand tool according to an embodiment of the invention.

FIG. 2 is a view illustrating a state when a cable and a housing of FIG. 1 are crimped.

FIG. 3 is an exploded view illustrating the crimping hand tool of FIG. 1.

FIGS. 4 and 5 are schematic views illustrating different states of a crimping hand tool.

FIGS. 6 and 7 are views illustrating different states after a housing and a signal cable are placed in a crimping slot.

FIG. 8 is a cross-sectional view illustrating a crimping hand tool according to another embodiment of the invention.

FIG. 9 is a cross-sectional view illustrating a crimping hand tool according to yet another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

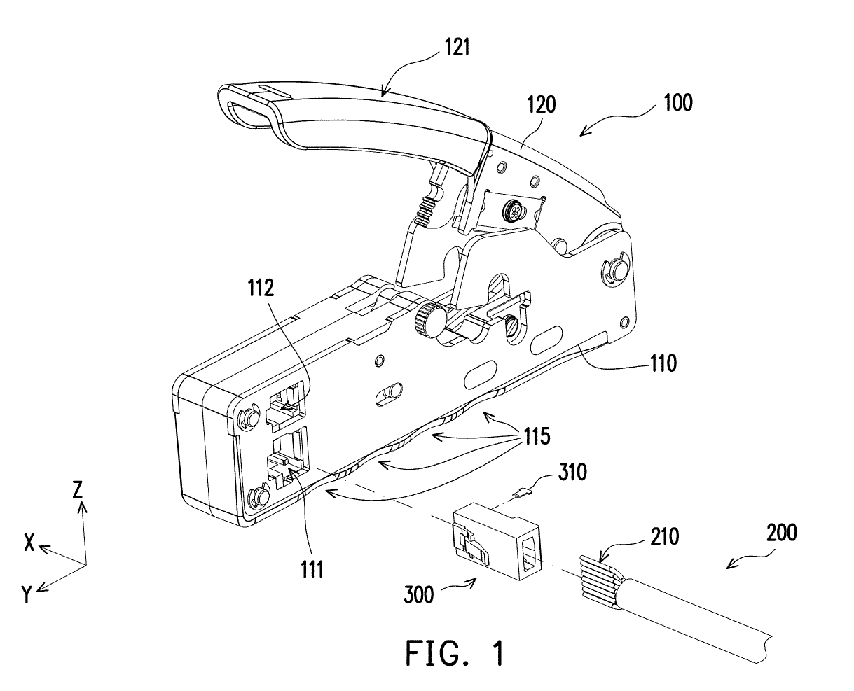

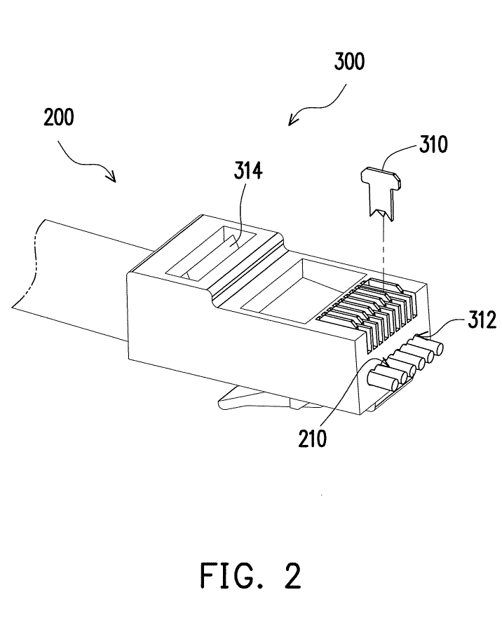

FIG. 1 is a schematic view illustrating a crimping hand tool according to an embodiment of the invention. FIG. 1 schematically illustrates an operation of a crimping hand tool 100 crimping a plurality of wires 210 of a cable 200 together to form a cable connector. A Cartesian coordinate system is provided herein for easy illustration. FIG. 2 is a view illustrating a state when the cable 200 and a housing 300 are crimped. After the cores 210 pass through the housing 300, a plurality of conductive strips 310 are correspondingly crimped onto the wires 210 by the crimping hand tool 100, so as to electrically connect the conductive strips 310 and the wires 210, thereby forming a cable connector. Referring to FIGS. 1 and 2, in the embodiment, the crimping hand tool 100 includes a first body 110 and a second body 120 pivoted to each other to rotate to be opened or closed. A user may handhold the crimping hand tool 100 to operate the crimping hand tool 100. As shown in FIG. 1, the thumb or a portion of the palm of the user near the thumb may be pressed against a pressing part 121 of the second body 120, and the rest four fingers of the user may hold a holding part 115 of the first body 110, so as to easily and effectively open or close the first body 110 and the second body 120 single-handedly. In the following, details of the structure of the crimping hand tool 100 are described, followed by detailed descriptions of the crimping operation of the crimping hand tool 100.

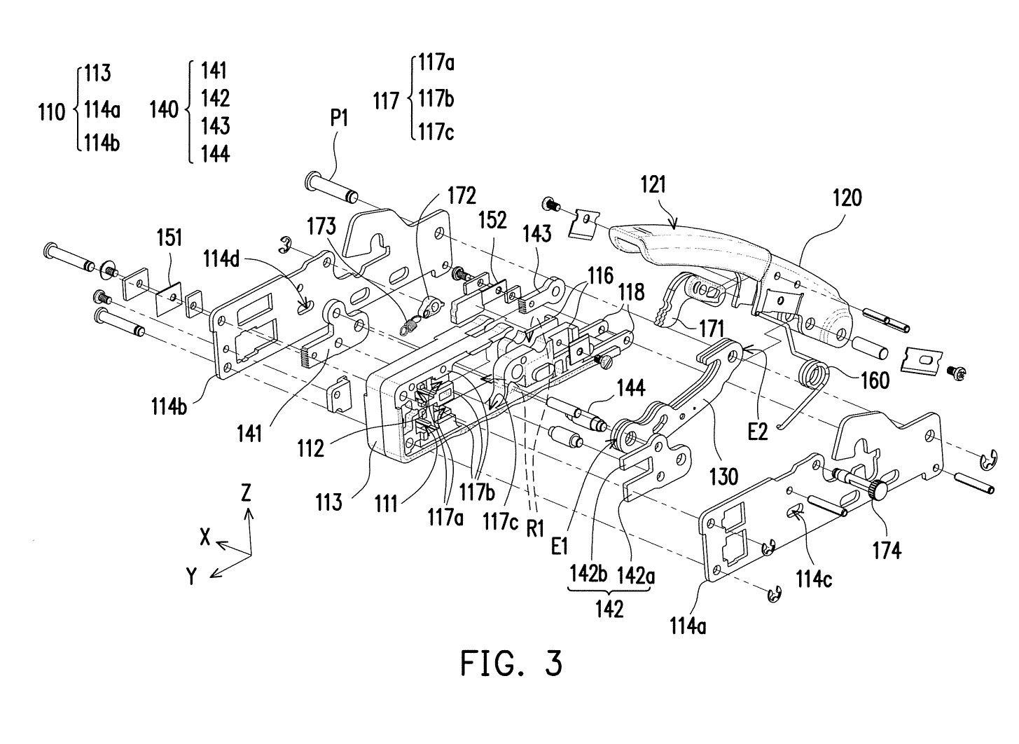

FIG. 3 is an exploded view illustrating the crimping hand tool of FIG. 1. Referring to FIG. 3, in the embodiment, the crimping hand tool 100 also includes a linking member 130 and a crimping assembly 140. The linking member 130 is movably disposed to the first body 110, and the linking member 130 has a first end E1 and a second end E2 opposite to each other. The second end E2 is pivoted to the second body 120, a location where the linking member 130 and the second body 120 are pivoted is adjacent to but different from a location where the first body 110 and the second body 120 are pivoted. The first body 110 has a guiding structure 117, and the crimping assembly 140 is pivoted to the first end E1 of the linking member 130. In addition, the crimping assembly 140 is slidably coupled to the guiding structure 117. Accordingly, when the second body 120 rotates with respect to the first body 110 to be opened or closed, the linking member 130 may thus be driven to slide and rotate in the first body 110, thus driving the crimping assembly 140 to crimp the wires 210 into the housing 300 in a crimping direction. Here, the crimping direction is a positive direction of the Y-axis and is orthogonal to a pivotal axial direction (X-axis) of the first body 110 and the second body 120 and is away from where the first body 110 and the second body 120 are pivoted.

Specifically, the first body 110 of the crimping hand tool 100 includes a main body 113 and a pair of side plates 114a and 114b. The main body 113 has an accommodating space R1, and the linking member 130 is movably disposed in the accommodating space R1. As shown in FIG. 3, the accommodating space RI includes a space penetrating through along the X-axis and a space extending along Y-axis in the main body 113. When the linking member 130 is installed in the first body 110, the linking member 130 is substantially disposed between two blocking walls 116 of the main body 113. The space extending along the Y-axis is formed between the blocking walls 116. The second body 120 is substantially pivoted between a pair of tail wings 118 at the end of the main body 113 and between the side plates 114a and 114b with the end of the second body 120 through a pivoting member P1. Meanwhile, a torsional spring 160 disposed in the first body 110 is elastically pressed against the first body 110 and the second body 120 for restoration when the first body 110 and the second body 120 are opened or closed with respect to each other.

Moreover, the guiding structure 117 of the embodiment substantially includes at least one guiding slot, at least one guiding protruding part, or at least one guiding surface in the first body 110. As shown in FIG. 3, the main body 113 includes two structural bodies 117a extending along the Y-axis and a plurality of protruding parts 117b. In the accommodating space R1, the space penetrating through along the X-axis and the structural bodies 117a is located between the structural bodies 117a and the blocking walls 116. In addition, the structural bodies 117b and the protruding parts 117b include two-dimensional (i.e., guiding surface) and three-dimensional structural features, and may serve to provide guidance for the crimping assembly 140 moving along Y-axis. In addition, after being assembled to the opposite sides of the main body 113, the side plates 114a and 114b may further provide a guidance effect. Besides, a bottom surface 117c located in the accommodating space R1 may also support and guide the crimping assembly 140 accordingly.

The pair of side plates 114a and 114b of the first body 110 respectively have bores 114c and 114d. The bores 114c and 114d are opposite to each other and intervened by the accommodating space RI. The crimping assembly 140 has a pivot shaft 144. Two ends of the pivot shaft 144 are respectively coupled to the bores 114c and 114d, so as to slide and rotate with respect to the side plates 114a and 114b. Respective extending directions of the bores 114c and 114d are parallel to the Y-axis and consistent with the crimping direction, thereby enabling sliding of the crimping assembly 140 along the Y-axis. In other words, the guiding structure 117 of the first body 110 substantially further includes the bores 114c and 114d provided together with the pivot shaft 144 passing through the linking member 130, so as to guide the crimping assembly 140.

Referring to FIGS. 1 and 3, the first body 110 further includes a first crimping slot 111 and a second crimping slot 112 respectively compatible with the housings 300 and the wires 200 of different specifications. A portion of the guiding structure 117 of the embodiment at the main body 113 is substantially located between the accommodating space R1 and the first crimping slot 111 and the second crimping slot 112. A first crimping member 141, a second crimping member 142, and a third crimping member 143 of the crimping assembly 140 respectively enter and exit the first crimping slot 111 and the second crimping slot 112 along the guiding structure 117.

Here, the first crimping slot 111 is described in detail as an example, while details of the second slot 112 will not be reiterated. In the embodiment, a main space of the first crimping slot 111 is located at the main body 113, and an opening of the first crimping slot 111 is located at the side plates 114a and 114b. In addition, the first crimping slot 111 is connected with the accommodating space R1 via the structural body 117a along the Y-axis. Here, the first crimping slot 111 is a penetrating structure along the X-axis, so that the housing 300 may be placed in the first crimping slot 111 to perform the crimping operation after the wires 210 pass through the housing 300. In addition, the first crimping member 141 and the second crimping member 142 are respectively pivoted to the first end E1 of the linking member 130 via the pivot shaft 144, so as to be driven by the linking member 130 to make a portion of the first crimping member 141 and a portion of the second crimping member 142 enter and exit the first crimping slot 111 synchronously and crimp different portions of the housing 300. On the X-axis, the linking member 130 is located between the first crimping member 141 and the second crimping member 142.

Besides, the crimping hand tool 100 further includes a first blade 151, assembled to the first crimping member 141. The first blade 151 moves along with the first crimping member 141 to enter and exit the first crimping slot 111, so as to cut off a portion of the wires 210 extending out of the housing 300. Details in this regard will be described in subsequent paragraphs.

As previously described, the first crimping slot 111 and the second crimping slot 112 only differ in the compatible types of housings and cables. Accordingly, the pressing assembly 140 further includes a third crimping member 143 linked between the first crimping member 141 and the second crimping member 142 and moving with the first crimping member 141 and the second crimping member 142. The third crimping member 143 and another portion of the second crimping member 142 synchronously enter and exit the second crimping slot 112. In other words, similar to the first crimping member 141 and the second crimping member 142 respectively having the structures of entering and exiting the first crimping slot 111 to crimp the housing 300, the wires 210, and the conductive strips 310 entering the first crimping slot 111, the third crimping member 143 serving to enter and exit the second crimping slot 112 also needs another structure to enter and exit the second crimping structure 112 synchronously to crimp another housing, wires, and conductive strips. Therefore, in the embodiment, the second crimping member 142 is substantially divided into two parts. A first pressing head 142a is configured to synchronously enter and exit the first crimping slot 111 with the first crimping member 141, and a second pressing head 142b is configured to synchronously enter and exit the second crimping slot 112 with the third crimping member 143. Here, the first pressing head 142a and the second pressing head 142b are integrally formed to reduce the total number of components and the size and simplify the design. Of course, in other embodiments not shown herein, by modifying the structural design, the first pressing head and the second pressing head may be separated as different components. Correspondingly, a second blade 152 also needs to be disposed in the crimping hand tool 100 in correspondence with the second crimping slot 112. The second blade 152 is assembled to the third crimping member 143 and moves along with the third crimping member 143 to enter and exit the second crimping slot 112, so as to cut off the extending wires during crimping.

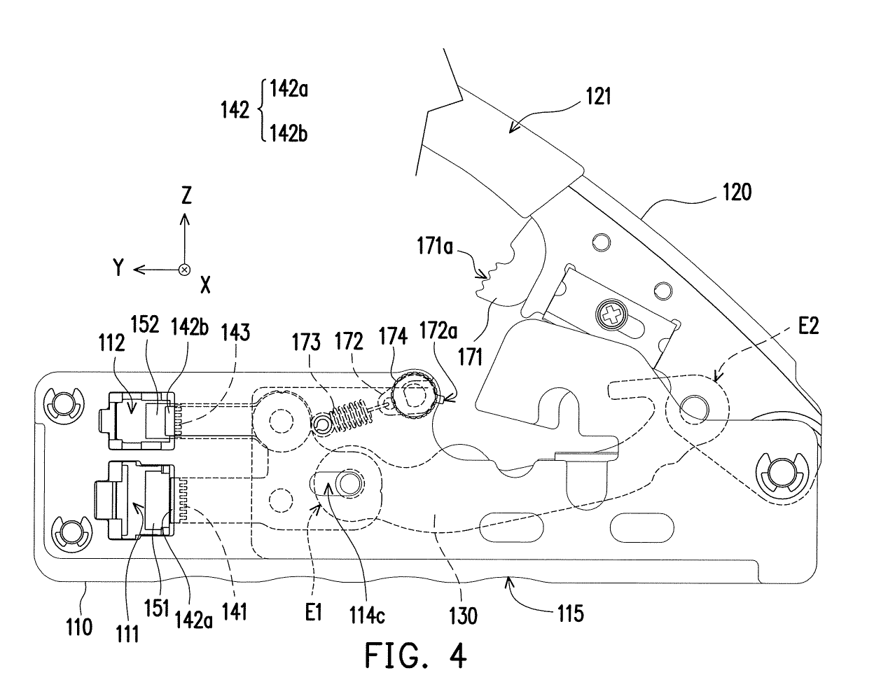

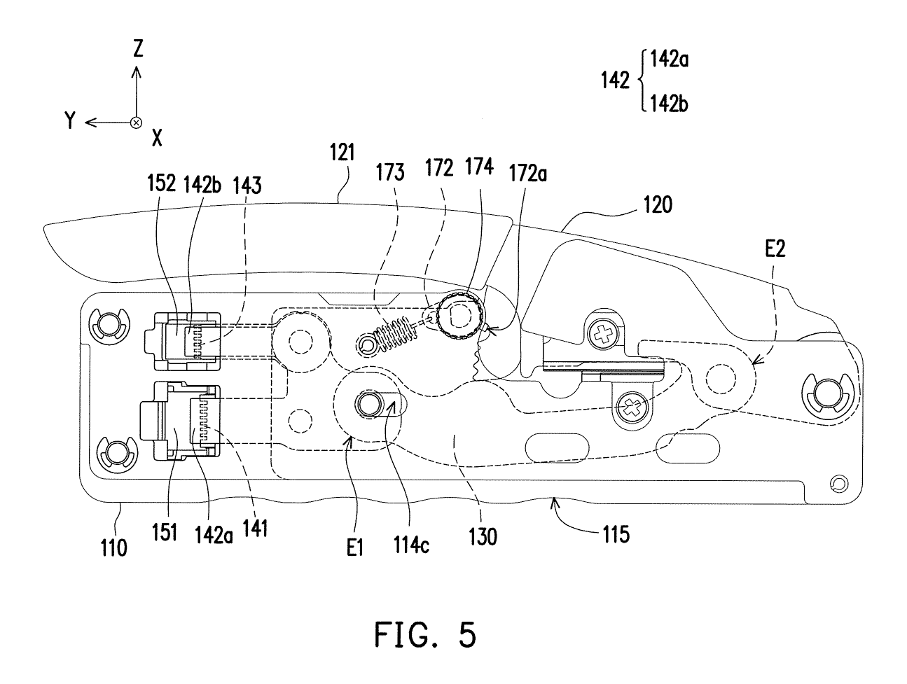

FIGS. 4 and 5 are schematic views illustrating different states of a crimping hand tool. In the following, some of the components are illustrated in broken lines for perspective illustration and for the convenience of subsequent descriptions. Referring to FIGS. 3 to 5, in the embodiment, the crimping hand tool 100 further includes a ratchet structure 171 and a stopping block 172. The ratchet structure 171 is disposed to the second body 120 and moves with the second body 120. The stopping block 172 is rotatably disposed to the first body 110. In addition, the stopping block 172 partially interferes with a movement path of the ratchet structure 171, so that the stopping block 172 may be temporarily locked to the ratchet structure 171 when the first body 110 and the second body 120 are opened or closed relative to each other.

Specifically, the crimping hand tool 100 further includes an elastic member 173 disposed to the first body 110 together with the stopping block 172. In addition, the elastic member 173 is connected between the main body 113 of the first body 110 and the stopping block 172. Here, the elastic member 173 constantly drives the stopping block 172 to rotate in a counterclockwise direction. The stopping block 172 pivoted to the first body 110 has a protruding part 172a. When the second body 120 is closed with respect to the first body 110, the protruding part 172a is driven for being located on a movement path of a tooth portion 171a of the ratchet structure 171, and thus temporarily locks the protruding part 172a to the tooth portion 171a and fixes relative positions of the first body 110 and the second body 120. Here, as shown in a process of FIGS. 4 to 5, the stopping block 172 is driven to rotate in a clockwise direction and deforms the elastic member 173. Namely, the direction that the elastic member 173 drives the stopping block 172 is opposite to the direction that the ratchet structure 171 drives the stopping block 172. Here, the temporary locking refers to that the user may exert an additional force to unlock the components or apply a force to lock the components again. Accordingly, when the first body 110 and the second body 120 are locked due to abnormal crimping during the crimping process, the user may rotate the stopping block 172 to detach the stopping block 172 and the ratchet structure 171 from each other to cancel the locking state.

In addition, the crimping hand tool 100 further includes a knob 174. The knob 174 is disposed at an exterior part of the first body 110 but passes through the main body 113 and is connected to the stopping block 172. The knob 174 is provided for the user to exert a force of rotation to detach the stopping block 172 from the ratchet structure 171.

In other embodiments not shown herein, the user may drive the stopping block 172 with a suitable tool (e.g., a driver) without the knob.

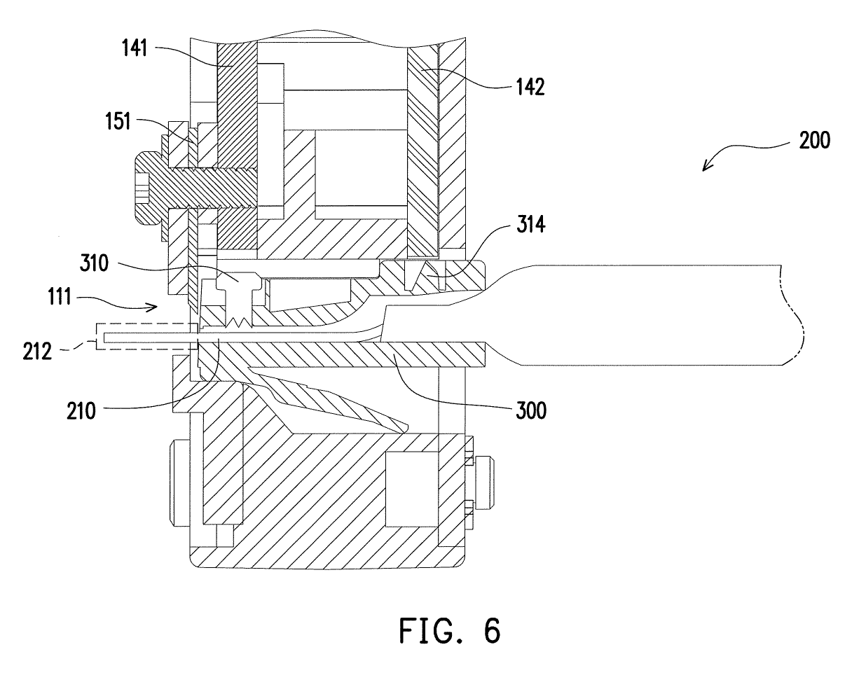

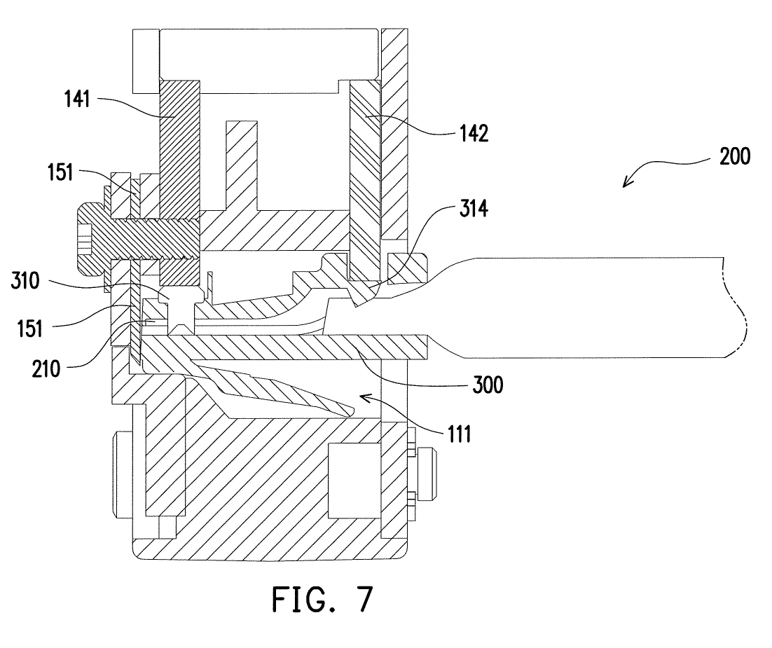

FIGS. 6 and 7 are views illustrating different states after a housing and a signal cable are placed in a crimping slot and respectively correspond to the crimping states of FIGS. 4 and 5. Referring to FIGS. 4 to 7, in the embodiment, the first end E1 of the linking member 130 is adjacent to the first crimping slot 111 and the second crimping slot 112. The second end E2 of the linking member 130 is adjacent to where the first body 110 and the second body 120 are pivoted. In addition, with the configuration of components such as the linking member 130 and the crimping assembly 140, the user may have the wires 210 of the cable 200 pass through the housing 300 with a portion 212 of the wires passing through and extending out of the housing 300. Then, the housing 300 and the wires 200 are placed into the first crimping slot 111 together. After the housing 300 and the wires 200 are placed into the first crimping slot 111, the portion 212 extends out of the first body 110 as well, as shown in FIG. 6. Then, the user exerts a force to the pressing part 121 of the second body 120 to perform the crimping operation shown in FIGS. 4 to 5. Specifically, the second body 120 and the first body 110 are closed with respect to each other to drive the linking member 130 to rotate in the clockwise direction while moving toward the positive direction of the Y-axis due to limitation and guidance of the guiding structure 117. Accordingly, the crimping assembly 140 is driven to move toward the positive direction of the Y-axis to enter the first crimping slot 111, as shown in the state of FIG. 7. In other words, the first crimping member 141 crimps the conductive strips 310 to the wires 210 to electrically connect the conductive strips 310 and the wires 210. Meanwhile, the second pressing member 142 may synchronously press down a crimping block 314 of the housing 300 to embed the crimping block 314 to the cable 200, so as to firmly attach the housing 300 to the cable 200 (and the wires 210).

Simultaneously when the crimping assembly 140 moves along the Y-axis to make the first crimping member 141 and the second crimping member 142 enter the first crimping slot 111, the first blade 151 locked to the first crimping member 141 also cuts off the portion 212 of the wires 210. Thus, the portion of the wires 210 remaining in the housing 300 may be aligned with an opening end of the housing 300.

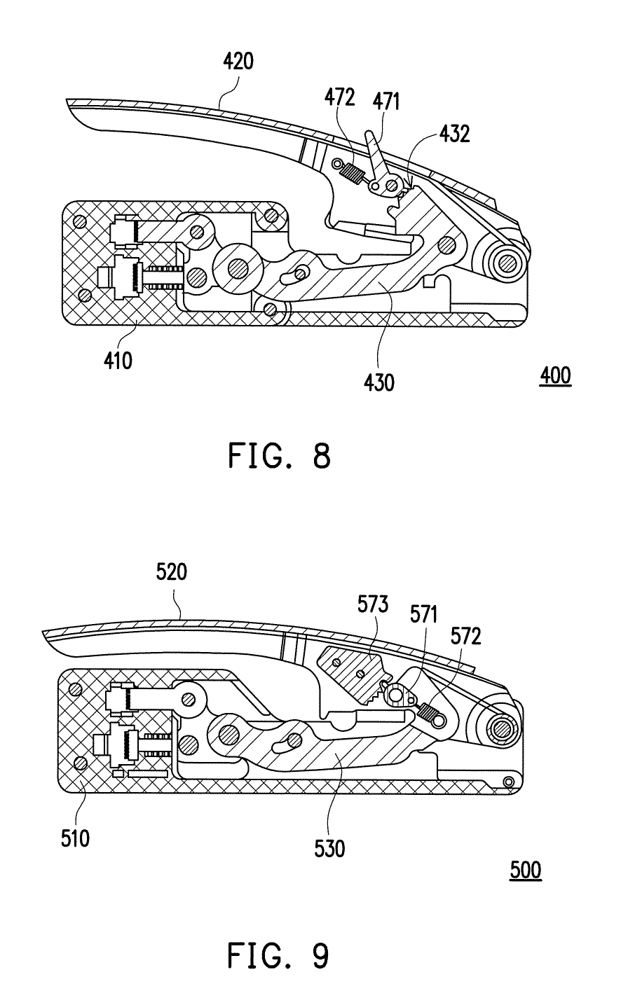

FIG. 8 is a cross-sectional view illustrating a crimping hand tool according to another embodiment of the invention. Referring to FIG. 8, what differs from the previous embodiment is that a ratchet structure 432 of a crimping hand tool 400 of the embodiment is disposed to a linking member 430 and faces toward a second body 420 (away from a first body 410). In addition, a stopping block 471 is rotatably disposed to the second body 420 and connected to the second body 420 via an elastic member 472. Similar to the previous embodiment, the elastic member 472 drives the stopping block 471 in a direction opposite to a direction that the ratchet structure 432 drives the stopping block 471. In another embodiment not shown herein, the positions of the ratchet structure and the stopping block (and the elastic member) may be exchanged, while the effect remains the same.

FIG. 9 is a cross-sectional view illustrating a crimping hand tool according to yet another embodiment of the invention. Referring to FIG. 9, what differs from the previous embodiment is that a ratchet structure 573 of a crimping hand tool 500 of the embodiment is disposed to a second body 520. In addition, a stopping block 571 is rotatably disposed to a first body 510 and is connected to the first body 510 via an elastic member 572. Similar to the previous embodiment, the elastic member 572 drives the stopping block 571 in a direction opposite to a direction that the ratchet structure 573 drives the stopping block 571. In another embodiment not shown herein, the positions of the ratchet structure and the stopping block may be exchanged, while the effect remains the same.

In view of the foregoing, according to the embodiments of the invention, with the first body and the second body pivoted to each other and the linking member between the first body and the second body in the crimping tool, the relative pivoting movement of the bodies and the guiding structure of one of the bodies enable pivoting and movement when the linking member is driven by the bodies, thereby driving the crimping assembly to crimp the cable and the housing. Since the linking member and the crimping assembly are substantially disposed to one of the bodies, and the crimping slots disposed to the body are able to cope with the housings and cables of different types, in addition to effectively reducing the size and making the crimping hand tool more broadly applicable, the user may also operate the crimping hand tool simply by holding.

In addition, the blade is disposed to the crimping assembly and follows the crimping assembly to enter and exit the crimping slot, so as to cut off the wires of the cable extending out of the housing and keep the wires in the housing aligned to the opening end of the housing. Since the cutting is performed synchronously with the crimping operation, the time of crimping is effectively reduced, and the convenience of operation is facilitated.

Moreover, with the configuration of the ratchet structure, the stopping block, and the elastic member of the crimping hand tool together, when the bodies are locked during the crimping process, the user may adjust the stopping block to release the bodies, thereby solving the problem effectively. Furthermore, in the embodiments, the ratchet structure, the stopping block, and the elastic member may be configured differently according to the structure of the bodies and the linking member.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A crimping hand tool for crimping a housing and a plurality of wires of a cable together to form a connector, the crimping hand tool comprising:
a first body, having a guiding structure;
a second body, pivoted to the first body and rotating with respect to the first body;
a linking member, having a first end and a second end opposite to each other, wherein the second end is pivoted to the second body; and
a crimping assembly, pivoted to the first end and slidably coupled to the guiding structure, wherein the second body and the first body rotate with respect to each other to move the linking member and drives the crimping assembly to crimp the wires into the housing in a crimping direction.

2. The crimping hand tool as claimed in claim 1, wherein the guiding structure is at least one guiding slot, at least one guiding protruding part, or at least one guiding surface in the first body.

3. The crimping hand tool as claimed in claim 1, wherein the first body comprises:
a main body, having an accommodating space, wherein the linking member is movably disposed in the accommodating space; and
a pair of side plates, respectively assembled to opposite sides of the main body and forming at least a portion of the guiding structure with the body.

4. The crimping hand tool as claimed in claim 3, wherein each of the pair of side plates has a bore, the pair of bores are opposite to each other and intervened by the accommodating space, the crimping assembly has a pivot shaft, two ends of the pivot axis are respectively coupled to the pair of bores, and an extending direction of each bore is consistent with the crimping direction.

5. The crimping hand tool as claimed in claim 3, wherein the first body has a first crimping slot connected with the accommodating space, the housing is moved into the first crimping slot after the wires pass through the housing, and the crimping assembly comprises:
a first crimping member and a second crimping member, respectively pivoted to the first end of the linking member via the pivot shaft, so as to be driven by the linking member to make a portion of the first crimping member and a portion of the second crimping member enter and exit the first crimping slot synchronously, thereby crimping different portions of the housing, wherein the linking member is located between the first crimping member and the second crimping member.

6. The crimping hand tool as claimed in claim 5, further comprising:
a first blade, assembled to the first crimping member, wherein the first blade moves along with the first crimping member to enter and exit the first crimping slot, so as to cut off a portion of the wires extending out of the housing.

7. The crimping hand tool as claimed in claim 5, wherein the first body further comprises a second crimping slot connected with the accommodating space, a plurality of wires of another cable are suitable to be moved to the second crimping slot after passing through another housing, and the crimping assembly comprises:
a third crimping member, linked between the first crimping member and the second crimping member, so as to move with the first crimping member and the second crimping member, wherein the third crimping member and another portion of the second crimping member enter and exit the second crimping slot synchronously.

8. The crimping hand tool as claimed in claim 7, further comprising:
a second blade, assembled to the third crimping member, wherein the second blade moves along with the third crimping member to enter and exit the second crimping slot, so as to cut off a portion of the wires of the another cable extending out of the another . housing.

9. The crimping hand tool as claimed in claim 7, wherein each of the first crimping slot and the second crimping slot penetrates through the main body in an axial direction, and the axial directions are respectively orthogonal to the crimping direction.

10. The crimping hand tool as claimed in claim 7, wherein the guiding structure is located between the accommodating space and the first crimping slot and the second crimping slot, and the first crimping member, the second crimping member, and the third crimping member respectively enter and exit the first crimping slot and the second crimping slot along the guiding structure.

11. The crimping hand tool as claimed in claim 5, wherein the guiding structure is located between the accommodating space and the first crimping slot, and the first crimping member and the second crimping member respectively enter and exit the first crimping slot along the guiding structure.

12. The crimping hand tool as claimed in claim 5, wherein the second end of the linking member is adjacent to where the first body and the second body are pivoted, and the first end of the linking member is adjacent to the first crimping slot.

13. The crimping hand tool as claimed in claim 1, wherein the first body comprises:
a main body, having an accommodating space, wherein the linking member is movably disposed in the accommodating space; and
a pair of side plates, respectively assembled to opposite sides of the main body, wherein each of the pair of side plates has a bore, the pair of bores are opposite to each other and intervened by the accommodating space, an extending direction of each bore is consistent with the crimping direction, a pivot shaft of the crimping assembly is located in the accommodating space, and two ends of the pivot shaft are respectively coupled to the pair of bores, wherein the pair of bores and at least one guiding slot, at least one guiding protruding portion, or at least one guiding surface of the main body form the guiding structure.

14. The crimping hand tool as claimed in claim 1, wherein a pivotal axial direction of the first body and the second body is orthogonal to the crimping direction.

15. The crimping hand tool as claimed in claim 1, wherein the crimping direction is away from where the first body and the second body are pivoted.

16. The crimping hand tool as claimed in claim 1, further comprising:
a ratchet structure, disposed to one of the first body and the second body, so as to move in accordance with rotating of the first body and the second body; and
a stopping block, rotatably disposed to the other of the first body and the second body, and partially interfering with a movement path of the ratchet structure, so as to temporarily lock the ratchet structure when the first body and the second body are rotating with respect to each other.

17. The crimping hand tool as claimed in claim 16, further comprising:
an elastic member, disposed to the first body or the second body together with the stopping block, wherein a direction that the elastic member drives the stopping block is opposite to a direction that the ratchet structure drives the stopping block.

18. The crimping hand tool as claimed in claim 16, wherein the ratchet structure faces away from where the first body and the second body are pivoted.

19. The crimping hand tool as claimed in claim 16, wherein the ratchet structure faces toward where the first body and the second body are pivoted.

20. The crimping hand tool as claimed in claim 1, further comprising:
a ratchet structure, disposed to one of the linking member and the second body, so as to move with the linking member or the second body; and
a stopping block, rotatably disposed to the other of the linking member and the second body, and partially interfering with a movement path of the ratchet structure, so as to temporarily lock the ratchet structure when the linking member and the second body move with respect to each other.

21. The crimping hand tool as claimed in claim 18, further comprising:
an elastic member, disposed to the linking member or the second body together with the stopping block, wherein a direction that the elastic member drives the stopping block is opposite to a direction that the ratchet structure drives the stopping block.
